(19) United States
(12) Patent Application Publication
(10) Pub. No.: US 2008/0187194 A1
(43) Pub. Date: Aug. 7, 2008

(54) CAD IMAGE NORMALIZATION

(76) Inventors: Daoxian H. Zhang, Los Gatos, CA (US); Yong Chu, Fremont, CA (US); Nariman Majdi-Nasab, San Jose, CA (US); Yue Shen, Santa Clara, CA (US); Erez E. Shermer, Raanana (IL)

Correspondence Address: Patent Legal Staff;Eastman Kodak Company, 343 State Street, Rochester, NY, 14650-2201, US

(21) Appl. No.: 11/671,142

(22) Filed: Feb. 5, 2007

(51) Int. Cl. G06K 9/00

(52) U.S. Cl. 382/128

(57) ABSTRACT

A method for normalizing an image of tissue from a patient. The image type is determined, then the background content values in the image data are distinguished from tissue content values according to the image type. Noise is reduced in the background content values. A look-up table is formed for remapping tissue content values to a predetermined range. Tissue content values are remapped according to the look-up table to provide a normalized image.

### FIELD OF THE INVENTION

The invention relates to medical image analysis, and more particularly, to a method for normalizing images obtained from different sources as a preparatory step for computer-aided diagnosis.

### BACKGROUND OF THE INVENTION

Some benefits of computer-aided diagnosis in radiology, and particularly in mammography, have been recognized. To date, there has been efforts directed toward computer-aided methods that assist the diagnostician to efficiently identify problem areas detected in a mammography image and to improve the accuracy with which diagnoses are made using this information.

One challenge faced in the design of computer-aided diagnostic (CAD) systems relates to a lack of standardization in results from equipment used to provide images. In mammography, for example, different vendors provide imaging systems that capture and process the images of breast tissue. Some systems, such as Full-Field Digital Mammography (FFDM) systems, obtain digital image data directly. Other Screen-Film Mammography (SFM) systems acquire images on film, which is then scanned to provide digital image data. While there are some standard practices that are followed from site to site for mammography imaging, such as obtaining a specific sequence of views, for example, there can be differences in the characteristics of images that are obtained. Mammography images may be acquired at different locations, using different equipment, at different times, or by different operators. As a result, image characteristics such as contrast and noise levels may vary according to the image source and imaging conditions. Moreover, once images are acquired, follow-on pre-processing can affect the way the image data is stored and presented. Depending on the type of mammography system, for example, images may be optimized for CAD processing or may be pre-processed for display, such as on a display monitor. Mammography CAD images are analyzed for various types of mass and spot/spot cluster feature characteristics that can be relatively subtle to detect.

It would be desirable for flexible CAD system design to adapt to mammographic images from any source. For example, a CAD system should be able to accept an FFDM image or an SFM image from any of a number of sources for processing, and to automatically adjust its processing to suit image characteristics.

U.S. Patent Application No. 2005/0008211 entitled “Lung Contrast Normalization on Direct Digital and Digitized Chest Images for Computer-Aided Detection (CAD) of Early-Stage Lung Cancer” by Xu et al. describes a method for conditioning diagnostic image data for diagnostic imaging using normalization factors for pixel size and intensity value.

Contrast adjustment by means of “contrast stretching” is described in U.S. Pat. No. 5,357,549 entitled “Method Of Dynamic Range Compression Of An X-Ray Image And Apparatus Effectuating The Method” to Maack et al.

U.S. Pat. No. 5,835,618 entitled “Uniform And Non-Uniform Dynamic Range Remapping For Optimum Image Display” to Fang et al. describes dynamic range remapping for enhancing an image in both dark and bright intensity areas by smoothing the data, such as through a low-pass filter.

None of the approaches of these references are well suited to the particular needs of mammography, for which images that have been obtained on different types of imaging apparatus can exhibit different characteristics in contrast and dynamic range and for which CAD utilities must have consistent image treatment in order to properly detect both mass and spot features.

Thus, there is a need for improved normalization methods, particularly for CAD mammography images that have been obtained from different sources.

### SUMMARY OF THE INVENTION

The present invention provides a method for normalizing an image of tissue from a patient comprising: determining an image type; distinguishing background content values in the image data from tissue content values according to the image type; reducing noise in the background content values; forming a look-up table for remapping tissue content values to a predetermined range; and remapping tissue content values according to the look-up table, providing a normalized image thereby.

The present invention provides normalization of image content so that images from different sources can be processed in a suitable manner by a CAD system. The present invention provides image normalization techniques that preserve the image content needed for accurate CAD assessment, whether the original image is obtained by scanning film or from an FFDM system.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings.

FIG. 1 is a block diagram showing mammography CAD workflow.

FIG. 2 are graphs showing noise content and a histogram for a mammography image scanned from film.

FIG. 3 is a histogram for a typical FFDM mammography system.

FIG. 4 is a plan view for a typical mammogram, showing sections used to detect background and tissue means.

FIG. 5 is a diagram showing pixel shifting for contrast adjustment.

FIG. 6 is a diagram showing linear normalization according to one embodiment.

FIG. 7 is a diagram showing a piecewise linear model for transformation according to one embodiment.

FIG. 8 is a block diagram showing possible types of image file that can be processed using methods of the present invention.

FIG. 9 is a block diagram showing the logic flow for tissue normalization with an FFDM digital image.

FIG. 10 is a block diagram showing the logic flow for tissue normalization with a scanned image for presentation.

FIG. 11 is a block diagram showing the logic flow for tissue normalization with a scanned image for processing.

FIG. 12 is a logic flow diagram showing steps for obtaining a feature-normalized image according to the present invention.

FIG. 13 is a graph that relates amplitude to pixel intensity for different exponential functions.

### DETAILED DESCRIPTION OF THE INVENTION

The following description is directed in particular to elements forming part of, or cooperating more directly with, apparatus in accordance with the invention. It is to be understood that elements not specifically shown or described may take various forms well known to those skilled in the art.

The method of the present invention provides image normalization without compromising the data that is analyzed by mammography CAD routines. Some methods, such as histogram equalization or distribution matching, can cause loss of image data. The method of the present invention adjusts image data characteristics to a standard in order to obtain usable input image content for detailed CAD analysis and more accurate detection of lesions and other abnormal conditions. The processing method of the present invention normalizes an image according to a set of standard characteristics, particularly with respect to the overall dynamic range of the imaged tissue and characteristics of features identified within the imaged tissue. The standard itself is generated using values obtained from a database of mammography images used for CAD analysis.

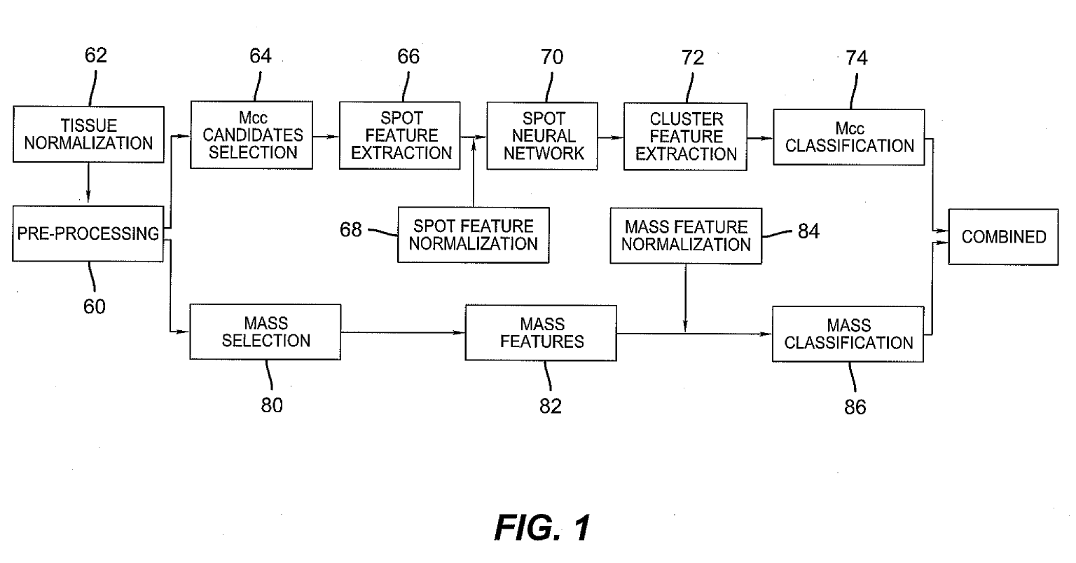

FIG. 1 shows a flow diagram for mammography CAD workflow according to the present invention. The mammography image, which can be obtained from a variety of sources, undergoes a preprocessing step 60. A tissue normalization process 62 is part of preprocessing step 60. Tissue normalization is applied to the complete mammography image. Following preprocessing step 60, segmentation and selection of mass and microcalcification (MCC) structures is executed, with image processing for each of these along a separate workflow path, as is illustrated in FIG. 1.

In the MCC workflow, spot microcalcification candidates are identified in an MCC candidate selection step 64. A spot feature extraction step 66 follows. Once MCC spot features have been identified, a spot feature normalization step 68 is executed, applying the feature normalization processing of the present invention, described subsequently. A spot neural network step 70 applies logic processing for further refinement of the MCC structures. A cluster feature extraction step 72 and an MCC classification step 74 complete the processing path used for MCC detection.

In the mass detection workflow, candidates are initially identified in a mass selection step 80. A mass features step 82 extracts features. A mass feature normalization step 84 is executed, as described subsequently. A mass classification step 86 completes the processing path for mass detection. Results from both MCC classification step 74 and mass classification step 86 are then combined and can be provided as CAD processing results.

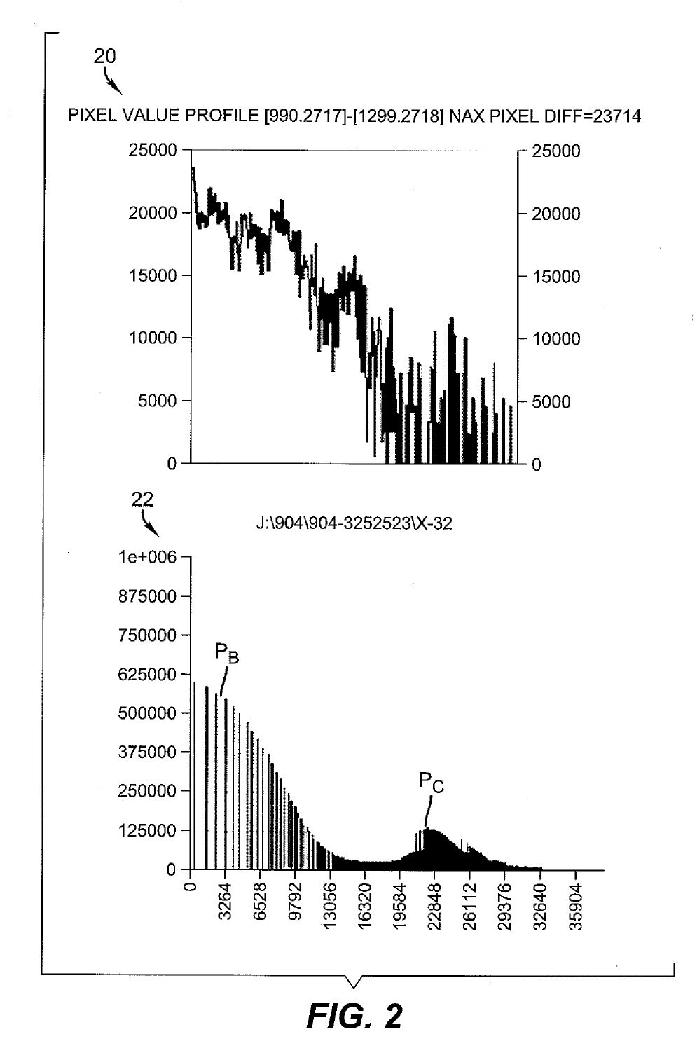

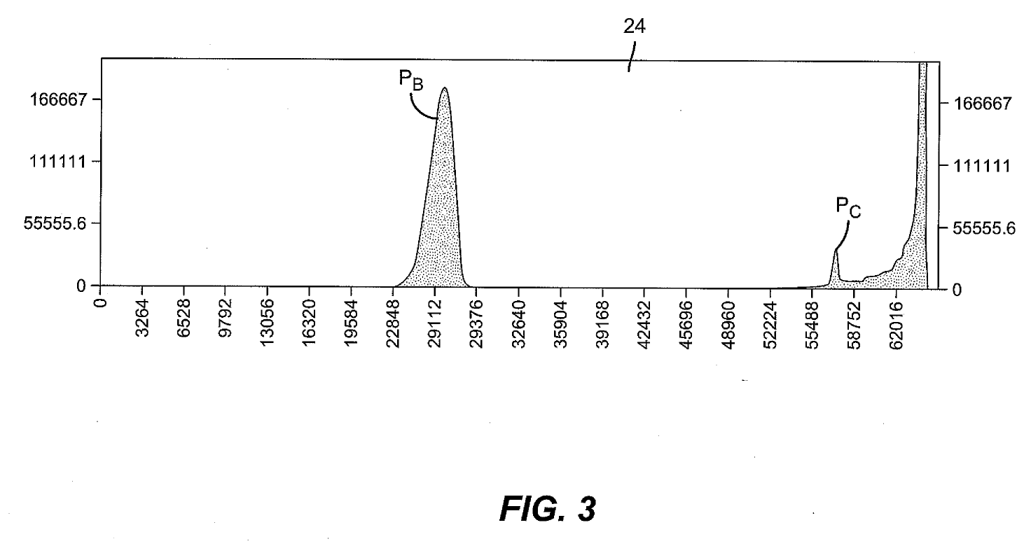

The graphs of FIGS. 2 and 3 include histograms that illustrate the reasoning for tissue normalization and its associated image processing for CAD processing. FIG. 2 graphs include a pixel value profile 20 that shows noise content and a histogram 22 for a mammography image scanned from film. FIG. 3 is a histogram 24 for a typical FFDM mammography system imaging the same tissue as that of FIG. 2. As shown from these two example histograms taken from different imaging systems, the ranges of data values used to represent the same tissue can vary depending on the type of system used. In addition, other preprocessing steps can also alter the data characteristics of the image to be optimized for image processing or for display, as is described subsequently.

As shown in pixel value profile 20 of FIG. 2, input images, particularly images that have been digitized from film media, can exhibit high levels of background noise. The noise level varies, changing from one digitizer to another, and may even change for images processed on the same digitizer but at different times. The existing background noise makes ensuing CAD processing difficult and reduces CAD performance. Moreover, background noise levels change from one image source to another as well. Thus, a step in the tissue normalization sequence is to identify background noise and to correct for excessive noise in the background data.

### Background Level Detection and Noise Reduction

A set of working assumptions make it possible to reduce noise levels in the background data, including the following:
Image background includes the area around the mammogram tissue. There may be additional markers and labels on the background. However, their use depends on images and sources, therefore their features are not considered for tissue normalization processing.
The tissue content is separable from the background in the image histogram. Background content resides in low intensity values, which means there exists a global intensity threshold that can be used to separate the background from the tissue.
The background level L is defined as the upper bound of the background B, so that given each pixel value g: L=Max_{g}{g ε B}.

The background threshold value can be determined using different methods. In one embodiment, histogram shape is used to identify background content and to distinguish it from image content of interest. Referring to histogram 22 in FIG. 2, the data obtained from a digitized image is shown to have two peaks, P_{B} and P_{C}. Peak P_{B}, occurring over values in a lower intensity range, indicates an overall background content. Peak P_{C}, occurring over values with some intensity, indicates an image content. As shown in a comparison between FIG. 2 (for a digitized image) and FIG. 3 (for an FFDM image), peaks P_{B} and P_{C} tend to differ between types of equipment and can even differ for the same equipment used by different operators or used on different days, for example. As a general observation, it has been noted that peak values for FFDM systems are more pronounced than those for digitized images from scanners. An intent is to find a threshold value between peaks P_{B} and P_{C} that can serve to distinguish background content from the image.

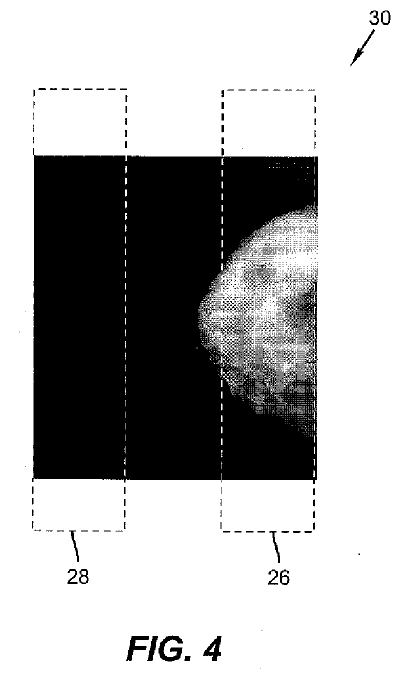

Conventionally, CAD mammography employs a defined set of images. Typically, two views of each breast are taken, along cranio-caudal (CC) and mediolateral oblique (MLO) planes. In the mammography image, breast tissue is on one side of the image or the other. Referring, for example, to FIG. 4, there is shown a mammography image 30 with breast tissue on the right side. Two non-overlapping sections of image 30 are identified: a right section 26 and a left section 28. In left section 28, the image background is the dominant component; in right section 26, breast tissue is the dominant component.

At least a portion of the section that contains breast tissue is identified as the tissue area or tissue ROI (region of interest). To identify a threshold value for background identification, the mean of this tissue area is defined as Gₜᵢₛₛᵤₑ. The mean of the background ROI is defined as G_{bkg}. Therefore, the background level lies within the range [G_{bkg}, Gₜᵢₛₛᵤₑ]. To obtain an optimal threshold value, the histogram of each of the partial images given in left and right section 28 and 26 is derived. Based on this histogram, a threshold t is then calculated to maximize the following objective function:

$$f = \frac{{( {μ}_{1} - {μ}_{2} )}^{2}}{{δ}_{within}^{2}} \times ( \frac{{N}_{g <= t}}{1 + {( {μ}_{1} - t )}^{2}} + \frac{{N}_{g > t}}{1 + {( {μ}_{2} - t )}^{2}} ) , ∀ t ∈ [ {G}_{bkg} , {G}_{tissue} ]$$

wherein:
t is the background threshold value;
h(g) is the histogram of the partial image;
the background and tissue area are

$${N}_{g \leq t} = {\sum }_{g \leq t} h ( g ) , {N}_{g > t} = {\sum }_{g > t} h ( g )$$

respectively;
means of the background and tissue are computed from left and right sections 28 and 26 and are, respectively:

$${μ}_{1} = \frac{{\sum }_{0 <= g <= t} g \times h ( g )}{{N}_{g \leq t}} , {μ}_{2} = \frac{{\sum }_{t < g <= Max} g \times h ( g )}{{N}_{g > t}} ;$$

within class variance is

$${σ}_{within}^{2} = \frac{{\sum }_{g \leq t} {( g - {μ}_{1} )}^{2} \times h ( g )}{{N}_{g \leq t}} + \frac{{\sum }_{g > t} {( g - {μ}_{2} )}^{2} \times h ( g )}{{N}_{g > t}} ;$$

$$\frac{{( {μ}_{1} - {μ}_{2} )}^{2}}{{σ}_{within}^{2}}$$

is a component that provides a measure of the inter-region contrast (between right and left sections 26 and 28 in the example of FIG. 4);

$$( \frac{{N}_{g <= t}}{1 + {( {μ}_{1} - t )}^{2}} + \frac{{N}_{g > t}}{1 + {( {μ}_{2} - t )}^{2}} )$$

is a component to balance the shape of the background and tissue distribution. With respect to function ƒ, this component gives a weighted sum of values above and below the background threshold value t. When the background is a sharp and exhibits a very high peak, the threshold shifts to the background, which is able to compensate for differences between digital (FFDM) images and digitized (scanned) images.

Using this type of calculation, the intensity threshold t that distinguishes background from tissue content can be identified for a given image. Once the background level can be determined, background pixels can be set to a standard value or otherwise conditioned, thereby reducing noise levels for this image data. With respect to the histogram curves of FIGS. 2 and 3, background noise is suppressed and background content is standardized, allowing subsequent image processing to work with data that represents tissue.

### Exponential Transformation

Digital images exhibit a generally uniform contrast level for tissue components. The uniform contrast results in a relatively minor distinction between nearby tissue structures. As may be inferred from histograms 22 and 24 in FIGS. 2 and 3, the pixel intensity distribution in digital images for the breast area is dense, concentrated, and located to the right or upper part of the histogram. This distribution is useful for separating the background noise from the image but causes difficulties in distinguishing the tissue components that have close characteristics within the breast area. An exponential transformation helps to amplify tissue components along the border and decreases the pixel density distribution in vicinity tissue components. The exponential transfer function attempts to augment contrast between tissue structures within the breast area and to suppress the background noise.

In this process, the pixel intensities in the image are stretched with two exponential functions and the results averaged out. The exponential functions used in one embodiment are:

gᵢ¹=a₁e^{b}^{₁}^{ƒ}^{ᵢ}−G_{offset} and gᵢ²=a₂e^{b}^{₂}^{ƒ}^{ᵢ}−G_{offset}

wherein:
ƒᵢ is the ith pixel intensity of the original image;
gᵢ¹ and gᵢ² are corresponding exponential functions for the ith pixel;
a₁, a₂, b₁, and b₂ are empirically determined constants. Values a₁, and a₂ are normalization factors;
G_{offset} is a value within the tissue background area, defined earlier.

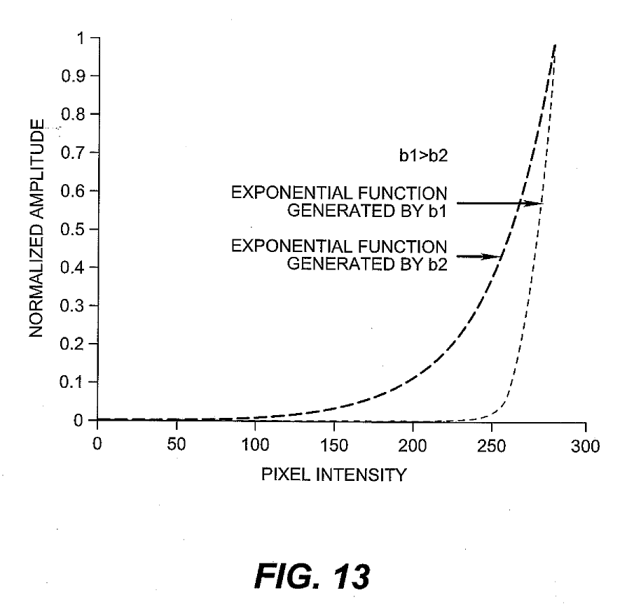

FIG. 13 shows the effect of b₁, and b₂ in the exponential functions. A larger b₁ value causes a steep slope in amplitude response for high intensity pixels and suppresses substantially low intensity pixel values. The output is averaged from the two gᵢ¹ and gᵢ² images:

gᵢ=gᵢ¹+gᵢ²

### Tissue Shifting

As can be seen from histograms 22 and 24 in FIGS. 2 and 3, the tissue mean value Gₜᵢₛₛᵤₑ can vary significantly from one type of imaging apparatus to the next. For normalization, the tissue mean value Gₜᵢₛₛᵤₑ is adjusted to a standardized (normalized) value, and this is preferably accomplished without altering the content of the acquired data. In one form, this means shifting the mean value of the distribution, as represented in the histogram; the whole histogram for tissue values would then be shifted up or down the scale, without changing the relationships between values. However, this type of gray value shifting, if improperly applied, can cause problems with tissue values that are distant from the mean value. For dark tissue pixels, for example, a downward shift risks shifting pixels to the background dynamic range. For bright tissue pixels, on the other hand, an upward value shift can result in undesirable saturation.

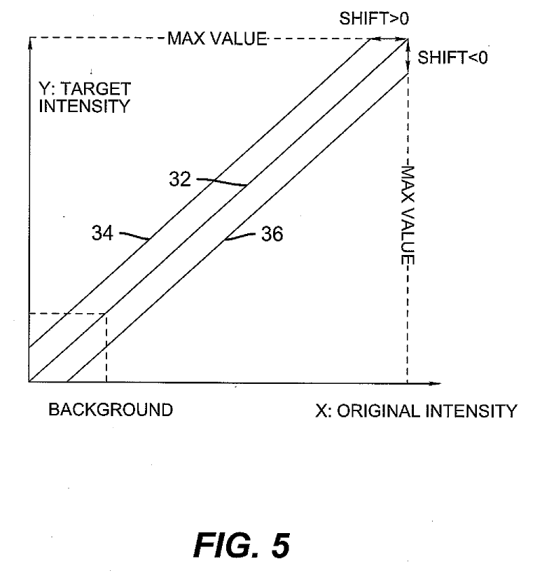

The graph of FIG. 5 is a diagram showing pixel shifting for contrast adjustment. The abscissa (x axis) represents original pixel intensity values; the ordinate (y axis) represents target, re-mapped intensity values. Gray value shifting adjusts the input:output intensity profile either to the right or to the left of its original position for an image, as represented by a line 32. A shift to the left indicated by a line 34 shows a positive shift that may cause saturation. A shift to the right indicated by a line 36 shows a negative shift that may cause some loss of dark tissue data.

In one embodiment, a consideration is to limit the maximum shifting value (where the Limit>0):

```
Variable shift = tissue mean − standard tissue mean;
If (|shift| < Limit)
        g′ = g + shift;
Else
        g′ = g − sign(shift)*Limit.
```

wherein:
tissue mean gives the mean value for tissue that is computed for an individual image; and
standard tissue mean gives an empirically determined mean value for tissue from a library of stored images.

### Linear Transformation

In addition to a difference in tissue mean, there can be a difference in the tissue dynamic range as well. It may be desirable to expand the dynamic range of image data to a desired dynamic range. To reduce the loss of information by the transformation, a scaling up or “zoom out” can be used (with a scale>1). Consideration should be given to correctly mapping the dark tissue and retaining the pixels for this tissue within the proper dynamic range for tissue, not in the dynamic range where the background lies.

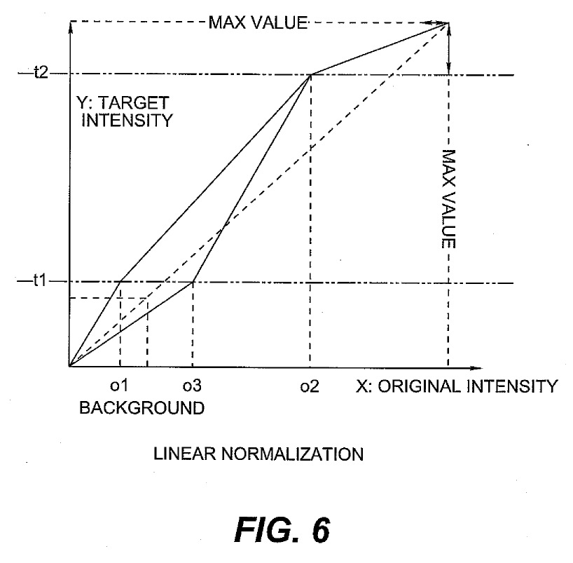

The method of the present invention maps intensity in different ranges. For pixels that are within a range established for tissue, a simple linear remapping can be performed, with interpolation to fix the remaining pixels that may lie outside these values. Referring to the graph of FIG. 6, for example, to map original intensity values in the range [o1, o2] to remapped values [t1, t2] or, similarly, values [o3, o2] to [t1, t2], the following sequence can be applied, where k represents the slope of the linear relationship, computed for each condition:

```
If g < o₁,
      k = t₁/o₁: g′ = k × g ;
If g >= o₁ and g <= o₂,
      k = (t₂ − t₁)/(o₂ − o₁): g′ = t₁ + k × (g − o₁) ;
If g > o₂,
      k = (MaxValue − t₂)/(MaxValue − o₂): g′ = t₂ + k × (g − o₂)
```

wherein MaxValue, as shown in FIGS. 5 and 6, is the maximum pixel intensity for the image.

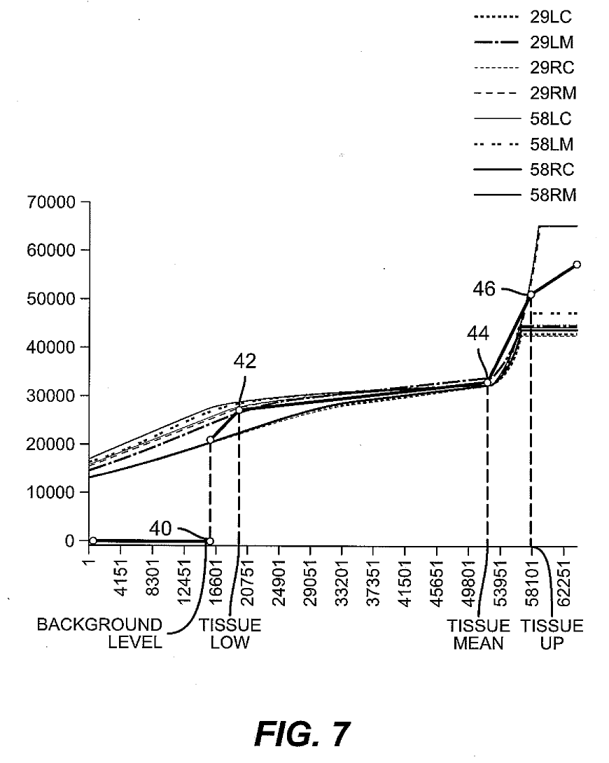

Piecewise linear transformation can be used, in which different ranges of pixels are handled differently, with linear transformations differing in slope, as in the example of FIG. 6. In one embodiment, according to certain computed values obtained from the image data, piecewise linear transformation is used to normalize data over a fixed number of segments, determined by a set of points. Referring to FIG. 7, four points of particular interest are obtained from the image data and used as vertex points in a piecewise linear transformation, namely a background threshold 40, a tissue lower bound 42, a tissue mean 44, and a tissue upper bound 46. For an input pixel value, this transformation provides a slope (scalar multiplier) and an additive offset for obtaining a remapped output pixel value.

The values for tissue lower bound 42 and tissue upper bound 46 can be determined in a number of ways. In one embodiment, these values are at ±2σ, where σ is the standard deviation. Alternately, a percentage of the tissue cumulative sum is used, so that tissue lower bound level 42 is the value nearest 1% of the tissue cumulative sum and tissue upper bound 46 is the value nearest 99% of the cumulative sum. Background values are suppressed and values above tissue upper bound 46 are flattened.

For the example shown in FIG. 7, the following sequence illustrates how piecewise linear transformation mapping is executed:

```
If g < O₁,
        g′ =T₁ ;
If g >= O₁ and g <= O₂,
        k = (T₂ − T₁)/(O₂ − O₁);
        g′ = T₁ + k × (g − O₁) ;
If g >= O₂ and g <= O₃,
        k = (T₃ − T₂)/(O₃ − O₂);
        g′ = T₂ + k × (g − O₂) ;
If g > O₃ and g <= O₄
        k = (T₄ − T₃)/(O₄ − O₃);
        g′ = T₃ + k × (g − O₃)
else g > O₄
        k = (MaxValue − T₄)/(MaxValue − O₄);
        g′ = T₄ + k × (g − O₄)
```

wherein:

g represents an input pixel value;

k provides a slope value;

T₁, T₂, T₃, and T₄ are remapped pixel values over each respective linear segment;

O₁ is the background level of the image;

O₂ is the tissue lower bound;

O₃ is the tissue mean; and

O₄ is the tissue upper bound.

It is noted that these linear calculations can be used to transform and remap each value from the original image data. In practice, a Look-Up Table (LUT) can be generated for remapping tissue content values to a predetermined range and applicable to log scale digital images based on these calculations, allowing a computationally fast remapping of pixel values. Some smoothing of values may be applied, for example, near transition points.

### Histogram Alteration

Where linear transformation are not used for one or more portions of an original image, other possible transforms for histogram alteration can alternately be used. This method typically suppresses intensities that are infrequently used and may have some utility for various mammography imaging applications. One known histogram adjustment method is histogram equalization which maps each intensity to form a flattened histogram that provides a more uniform distribution. The operation effectively stretches densely populated values, and suppresses intensities infrequently used.

A general solution is histogram specification, which maps the histogram of the image to a desired curve given by the user. This can be accomplished using a pair of images from the same object: one as the original image, the other as the desired image with desired dynamic range. With histogram specification, a look up table (LUT) can be generated to map the similar original images to the desired ones. However, histogram equalization can expand intensity values most often used but can suppress values that are particularly useful for cancer detection. Thus, while this imaging method may be used for generating an LUT according to the present invention, it may not be optimal as a general solution for normalization.

### Generating a Tissue-Normalized Image

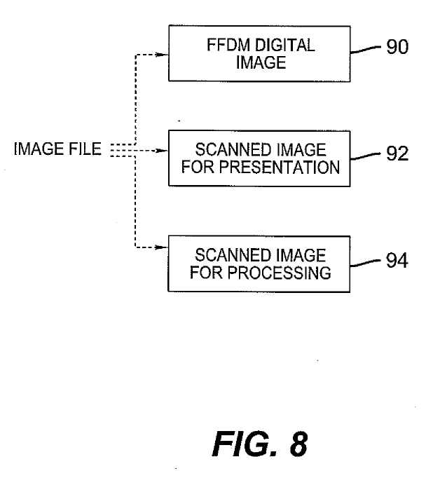

FIGS. 8 through 11 show the logic flow for generating a tissue-normalized image using the method of the present invention. FIG. 8 shows an initial step, in which an image file is identified as being of one characteristic type, either an FFDM digital image 90, a scanned image for presentation 92, or a scanned image for processing 94. The type of image data file largely depends on the equipment type and manufacturer. Identification may be automated, using information provided in the file header, for example, or may be configured for the equipment site. These different image types can vary in characteristics such as bit depth and pixel dimensions, as well as in the range of intensity values representing background and tissue content, as was described earlier with reference to FIGS. 2 and 3.

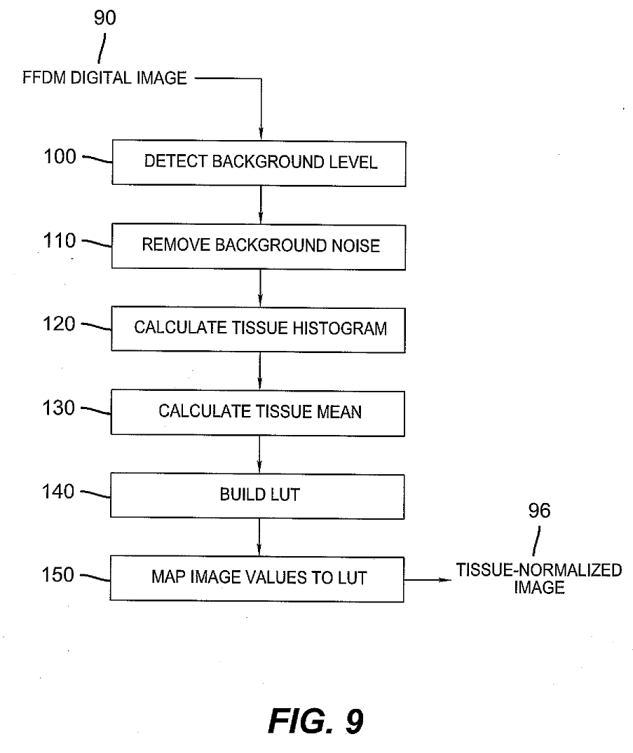

The flow chart of FIG. 9 shows a sequence that is used to generate a tissue-normalized image 96 with FFDM digital image 90 (FIG. 8) as its input.

A detect background level step 100 identifies image background values using known distribution characteristics from this type of digital imaging equipment, as was described with reference to FIG. 3. A remove background noise step 110 follows, in which background content is suppressed, along with noise being generated at background levels. A tissue histogram step 120 generates a histogram of tissue values from the background-suppressed image. A tissue mean calculation step 130 calculates the tissue mean value from this histogram. For an LUT generation step 140, tissue shifting, as was shown in FIG. 5 and described earlier, is used to calculate an appropriate image shift for normalization and to generate an LUT accordingly. Then, to form tissue-normalized image 96, an LUT mapping step 150 is executed.

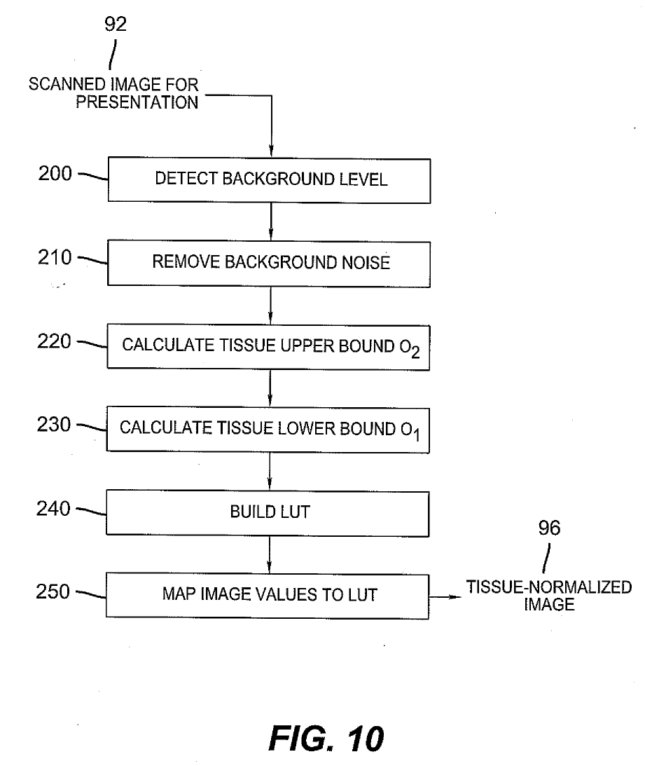

The flow chart of FIG. 10 shows a sequence that is used to generate a tissue-normalized image 96 (FIG. 8) with scanned image for presentation 92 as its input. A detect background level step 200 identifies image background values using known distribution characteristics from this type of digital imaging equipment, as was described with reference to FIG. 2. A remove background noise step 210 follows, in which background content is suppressed, along with noise being generated at background levels. Tissue upper and lower bound calculation steps 220 and 230 obtain these values from the image data for pixel remapping. For an LUT generation step 240, linear transformation, as described earlier, is used to generate suitable values. To form tissue-normalized image 96, an LUT mapping step 250 is then executed.

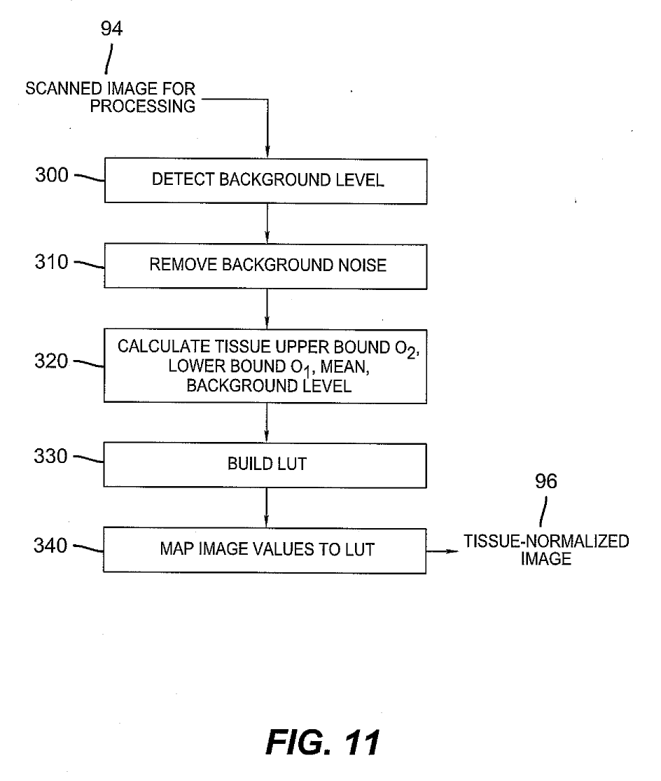

The flow chart of FIG. 11 shows a basic sequence that is used to generate a tissue-normalized image 96 (FIG. 8) with scanned image for processing 94 as its input. A detect background level step 300 identifies image background values using known distribution characteristics from this type of digital imaging equipment. A remove background noise step 310 follows, in which background content is suppressed, along with noise being generated at background levels. Tissue upper and lower bound and tissue mean is calculated in a values calculation step 320 that uses these values from the image itself. For this sequence, a piecewise linear transformation is used in an LUT generation step 330. To form tissue-normalized image 96, an LUT mapping step 340 is then executed.

### Feature Normalization

Referring again to the logic flow shown in FIG. 1, feature normalization applies after tissue normalization is completed and may be used for processing both MCC spots and masses detected in the mammogram. An initial step for either spot feature normalization step 68 or mass feature normalization step 84 is to determine whether feature normalization is needed in a particular case. For this purpose, empirical results from a standard database of example images are used as a benchmark and compared against results from the feature image to determine whether or not normalization is performed.

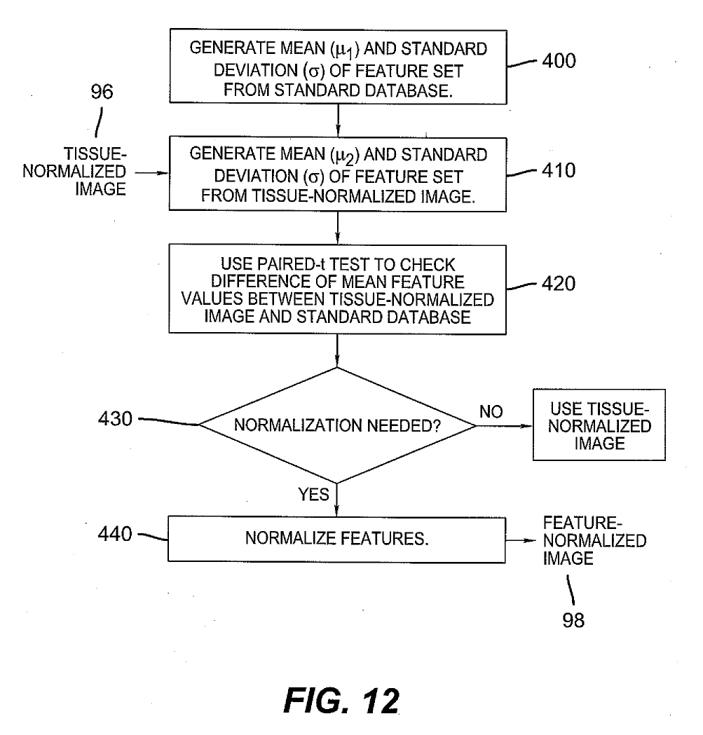

FIG. 12 shows the logic flow sequence for making this determination. In a values computation step 400, mean μ₁ and standard deviation σ values are generated from the standard database. A second values computation step 410 generates mean μ₁ and standard deviation σ values from the original tissue-normalized image 96, which has been formed in accordance with the image type, using the appropriate one of the procedures outlined in FIGS. 9, 10, or 11. A statistical comparison step 420 is executed to determine the statistical significance of the difference between the standard database images and the tissue-normalized image. In one embodiment, a paired-t test, known to those skilled in the statistical analysis arts, is used to assess the difference between mean feature values. For a paired-t test, small values of P, less than 0.1, indicate the need for normalization. Other types of statistical tests could alternately be used to determine whether or not further normalization is needed. A decision step 430 is executed to determine whether feature normalization can be bypassed, allowing tissue-normalized image 96 to be used without normalization, or if feature normalization is desired.

A normalization step 440 is applied if desired. Normalization methods can be linear or non-linear. In one non-linear method, the feature distribution from the image source can be mapped to the standard distribution, allowing the same basic transform to apply for all images from a particular source. A linear method, on the other hand, operates on the assumption of a linear relationship between the digital feature space and analog feature space:

ƒ′=A×ƒ+B.

E[ƒ′]=A×E[ƒ]+B, Var[ƒ′]=A²×Var[ƒ]
where operator E[ ] stands for expectation value. For example:

E(x)=∫xƒ(x)dx
Therefore the transform is f′=A×ƒ+B, in which

A=Sqrt(Var[ƒ′]/Var[ƒ]),

B=E[ƒ′]−A×E[ƒ].
Both A and B can be determined in a training phase of the algorithms and can be put in configuration files for later use. Each feature has its own A and B values. For each individual feature, values A and B map linearly.
The normalized features should be within the range defined by [Min, Max], if f′<Min, set f′=Min, if f′>Max, set f′=Max.

The method of the present invention allows CAD software to work with mammography image data that has been obtained from any of a number of different imaging systems. Using this capability, images obtained from equipment of various manufacturers can be processed and used on a single CAD system, providing cost savings over alternative methods.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. For example, any of a number of methods could be used for deriving a background threshold value or minimizing or eliminating background noise. A number of statistical tests could be used to determine the need for features normalization.

What is provided is an apparatus and method for normalizing images obtained from different sources as a preparatory utility for computer-aided diagnosis.

PARTS LIST

| | |
|---|---|
| 20 | Pixel value profile |
| 22, 24 | Histogram |
| 26, 28 | Section |
| 30 | Mammography image |
| 32, 34, 36 | Line |
| 40 | Background threshold |
| 42 | Tissue lower bound |
| 44 | Tissue mean level |
| 46 | Tissue upper bound |
| 60 | Preprocessing step |
| 62 | Tissue normalization process |
| 64 | MCC candidate selection step |
| 66 | Spot feature extraction step |
| 68 | Spot feature normalization step |
| 70 | Spot neural network step |
| 72 | Cluster feature extraction step |
| 74 | MCC classification step |
| 80 | Mass selection step |
| 82 | Mass features step |
| 84 | Mass feature normalization step |
| 86 | Mass classification step |
| 90 | FFDM digital image |
| 92 | Scanned image for presentation |
| 94 | Scanned image for processing |
| 96 | Tissue-normalized image |
| 100 | Detect background level step |
| 110 | Remove background noise step |
| 120 | Tissue histogram step |
| 130 | Tissue mean calculation step |
| 140 | LUT generation step |
| 150 | LUT mapping step |
| 200 | Detect background level step |
| 210 | Remove background noise step |
| 220 | Upper bound calculation step |
| 230 | Lower bound calculation step |
| 240 | LUT generation step |
| 250 | LUT mapping step |
| 300 | Detect background level step |
| 310 | Remove background noise step |
| 320 | Values calculation step |
| 330 | LUT generation step |
| 340 | LUT mapping step |
| 400 | Values computation step |
| 410 | Values computation step |
| 420 | Statistical comparison step |
| 430 | Decision step |
| 440 | Normalization step |
| P_{B}, P_{C} | Peak |

1. A method for normalizing an image of tissue from a patient, comprising:
determining an image type of the image;
distinguishing background content values in the image from tissue content values according to the image type;
reducing noise in the background content values;
forming a look-up table for remapping tissue content values to a predetermined range; and
remapping tissue content values according to the look-up table to provide a normalized image.

2. The method of claim 1 wherein determining the image type comprises determining the image to be any of the following:
(a digitally obtained image;
an image scanned and digitized from a film medium and in a format pre-processed for display; or
an image scanned and digitized from the film medium and in a format pre-processed for image processing.

3. The method of claim 1 wherein distinguishing background content values comprises:
calculating a mean background value from a first histogram obtained from a first portion of the image;
calculating a mean tissue value from a second histogram obtained from a second portion of the image, wherein the first and second portions are non-overlapping; and
obtaining a background threshold value between the mean background value and the mean tissue value according to a function that is the product of a first value that quantifies contrast between first and second portions, and a second value that comprises a weighted sum of values above and below the background threshold value.

4. The method of claim 1 wherein forming a look-up table comprises:
a) generating a histogram of tissue content values for the image;
b) calculating at least one of a tissue mean, an upper bound, and a lower bound for tissue content;
c) remapping each original tissue content value to an adjusted value according to the calculations of step b); and
d) storing each adjusted value in the look-up table, indexed by its corresponding original tissue content value.

5. The method of claim 4 wherein the remapping in step c) is substantially linear.

6. The method of claim 1 further comprising:
identifying a feature of interest from the normalized image;
comparing a feature mean and a feature standard deviation computed from pixels within the feature of interest with a reference mean and reference standard deviation computed using a set of reference images to obtain a statistical measure of the difference; and
normalizing the feature of interest or bypassing normalization according to the statistical measure.

7. The method of claim 1 wherein reducing noise in the background content values comprises setting background pixels to a predetermined value.

8. The method of claim 1 wherein forming a look-up table for remapping tissue content values comprises:
a) generating a histogram of image data values;
b) calculating a background threshold value according to the histogram;
c) assigning data values lower than the threshold value to a background data value;
d) calculating a tissue mean, an upper bound, and a lower bound for tissue content;
e) remapping each original tissue content value to an adjusted value according to the calculations of step d); and
f) storing each adjusted value in the look-up table, indexed by its corresponding original tissue content value.

9. A method for normalizing an image of tissue from a patient comprising:
determining an image type of the image;
distinguishing background content values in the image from tissue content values according to the image type;
calculating a histogram of the tissue content values;
calculating the tissue mean according to the histogram;
forming a look-up table for remapping tissue content values to a predetermined range by shifting the tissue mean to an alternate value, while preserving the distribution of tissue image data values about the mean; and
remapping tissue content values according to the look-up table to provide a normalized image.

10. A method for normalizing an image of tissue from a patient comprising:
a) determining the image type of the image;
b) distinguishing background content values in the image from tissue content values according to the image type;
c) reducing noise in the background content values;
d) forming a look-up table for remapping tissue content values to a predetermined range;
e) remapping tissue content values according to the look-up table to provide a normalized image;
f) identifying features of interest within the normalized image;
g) calculating mean and standard deviation values of similar features from a stored database of images;
h) calculating mean and standard deviation values of similar features from the normalized image; and
i) performing a statistical comparison of mean and standard deviation values calculated in g) and h).

11. The method of claim 10 wherein the statistical comparison uses a paired-t test.
